(19) United States
(12) Patent Application Publication
(10) Pub. No.: US 2005/0041744 A1
(43) Pub. Date: Feb. 24, 2005

(54) Method of and system to set a quality of a media frame

(76) Inventors: Wilhelmus Verhaegh, Eindhoven (NL); Clemens Christiaan Wuest, Eindhoven (NL)

Correspondence Address: U.S. Philips Corporation;Intelletual Property Department, P O Box 3001, Briarcliff Manor, NY, 10510, US

(21) Appl. No.: 10/497,866

(22) PCT Filed: Dec. 9, 2002
(86) PCT No.: PCT/IB02/05276

(30) Foreign Application Priority Data
Dec. 10, 2001 (EP) 01204791.6

(51) Int. Cl. H04N 7/12; H04B 1/66

(52) U.S. Cl. 375/240.26; 375/240

(57) ABSTRACT

The invention relates to adaptive scheduling and resource management techniques such as Markov decision problems that can be used to achieve maximum perceived user quality within time and resource constrained environments.

The invention relates to a method of setting a quality of a media frame.

The invention further relates to a system of setting a quality of a media frame.

The invention further relates to a computer program product designed to perform such a method.

The invention further relates to a storage device comprising such computer program product.

The invention further relates to a television set and a set-top box comprising such system.

An embodiment of the method and the system of the kind set forth above is described in non pre-published EP application EP 0109691 with attorney reference PHNL010327. Here, a method of running an algorithm and a scalable programmable processing device on a system like a VCR, a DVD-RW, a hard-disk or on an Internet link is described. The algorithms are designed to process media frames, for example video frames while providing a plurality of quality levels of the processing. Each quality level requires an amount of resources. Depending upon the different requirements for the different quality levels, budgets of the available resources are assigned to the algorithms in order to provide an acceptable output quality of the media frames. However, the contents of a media stream varies over time, which leads to different resource requirements of the media processing algorithms over time. Since resources are finite, deadline misses are likely to occur. In order to alleviate this, the media algorithms can run in lower than default quality levels, leading to correspondingly lower resource demands.

It is an object of the invention to provide a method according to the preamble that uses a quality level control strategy that controls quality level changes of processing a media frame in an improved way. To achieve this object the method of setting a quality of a media frame by a media processing application comprises:
a step of determining an amount of resources to be used for processing the media frame;
a step of controlling the quality of the media frame based on relative progress of the media processing application calculated at a milestone.

By using the relative progress of the application with respect to the periodic deadlines as the time until the deadline of the milestone, expressed in deadline periods, it can be determined if a deadline miss is going to occur. To prevent the deadline miss, the quality of the processing algorithm can be adapted at a milestone which can improve a perceived quality of the media frame by a user. A further advantage is that the number of quality level changes can be better controlled while maintaining an acceptable quality level, because quality level changes can be perceived as non-quality by a user.

An embodiment of the method according to the invention is described in claim 2. By modeling the quality control strategy as a Markov decision problem, the quality control strategy can be seen as a stochastic decision problem. A stochastic decision problem is disclosed in Stochastic Dynamic Programming, PhD thesis, Mathematisch Centrum Amsterdam, 1980, J. van der Wal. By solving the Markov decision problem, the quality effects of different strategies can be predicted more easily.

An embodiment of the method according to the invention is described in claim 3. By using a decision strategy that maximizes a sum of revenues over all transitions, deadline misses can be better prevented.

An embodiment of the method according to the invention is described in claim 4. By using a decision strategy that maximizes average revenue per transition, the number of quality changes can be controlled better.

It is a further object of the invention to provide a system according to the preamble that uses a quality level control strategy that controls quality level changes in an improved way. To achieve this object the system to set a quality of a media frame by a media processing application comprises:
determining means conceived to determine an amount of resources to be used for processing the media frame;
controlling means conceived to control the quality of the media frame based on relative progress of the media processing application calculated at a milestone.

These and other aspects of the invention will be apparent from and elucidated with reference to the embodiments described hereinafter as illustrated by the following Figures:

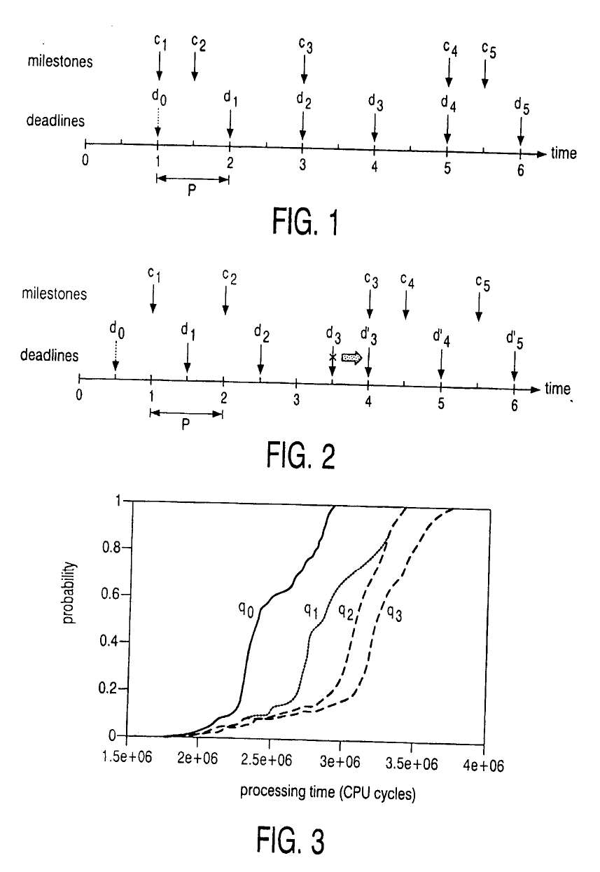

FIG. 1 illustrates an example of a timeline;

FIG. 2 illustrates a further example of a timeline;

FIG. 3 illustrates a cumulative distribution function of the processing time required to decode one frame;

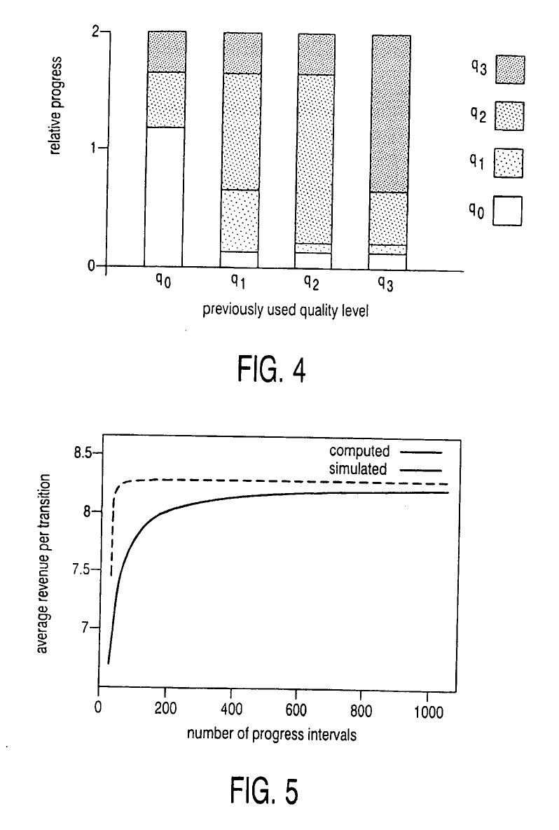

FIG. 4 illustrates an example control strategy;

FIG. 5 illustrates the average revenue per transition for problem instances;

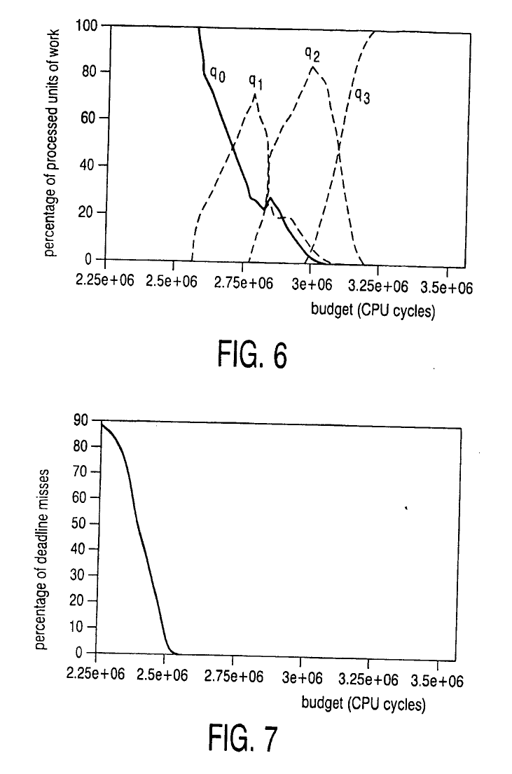

FIG. 6 illustrates the quality level usage;

FIG. 7 illustrates the percentage of deadline misses;

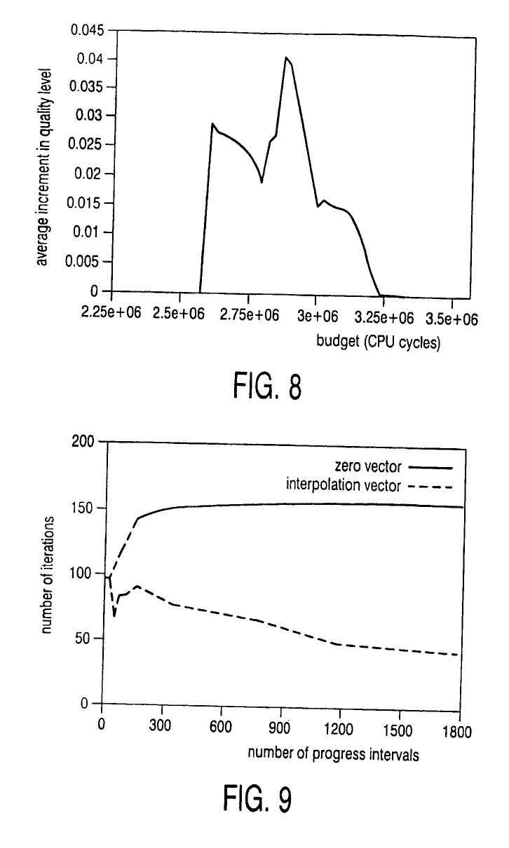

FIG. 8 illustrates the average increment in quality level;

FIG. 9 illustrates the number of iterations for example approaches;

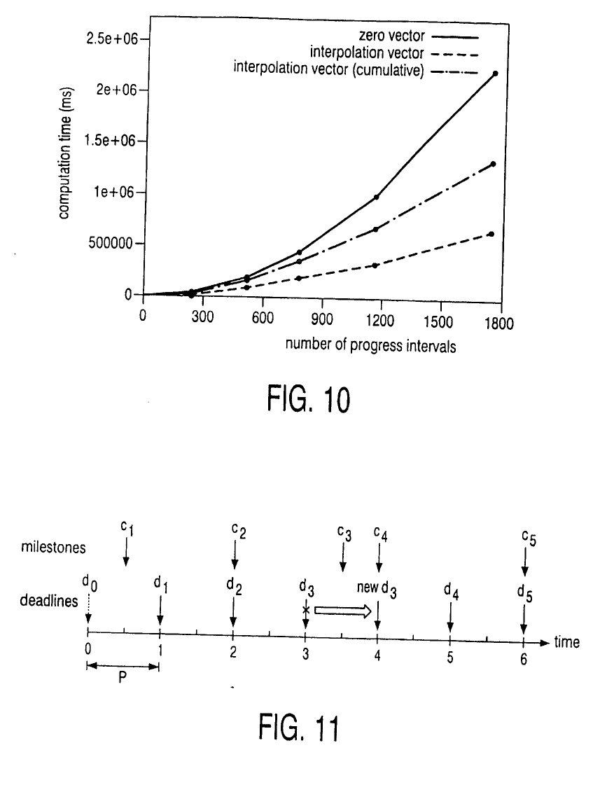

FIG. 10 illustrates the computation time that is measured;

FIG. 11 illustrates the skipping deadline miss approach;

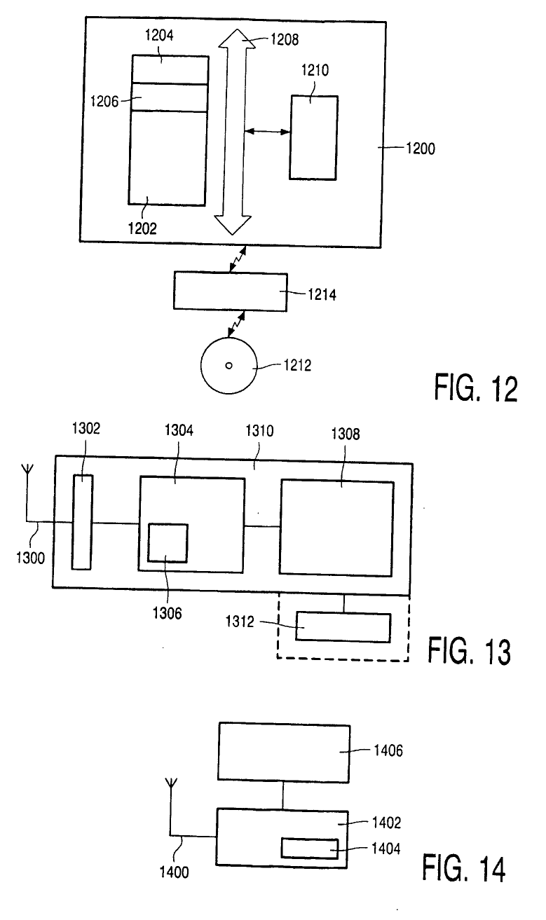

FIG. 12 illustrates a system according to the invention in a schematic way;

FIG. 13 illustrates a television set according to the invention in a schematic way;

FIG. 14 illustrates a set-top box according to the invention in a schematic way.

Nowadays, many media processing applications create a CPU load that varies significantly over time. Hence, if such a media processing application is assigned a lower CPU-budget than needed in its worst-case load situation, deadline misses are likely to occur. This problem can be alleviated by designing media processing applications in a scalable fashion. A scalable media processing application can run in lower than default quality levels, leading to correspondingly lower resource demands. One problem is to find a quality level control strategy for a scalable media processing application, which has been allocated a fixed CPU budget. Such a control strategy should minimize both the number of deadline misses and the number of quality level changes, while maximizing the quality level.

According to the invention, this problem is modeled as a Markov decision problem. The model is based on calculating relative progress of an application at its milestones. Solving the Markov decision problem results in a quality level control strategy that can be applied during run time with only little overhead. This approach is evaluated by means of a practical example, which concerns a scalable MPEG-2 decoder.

Consumer terminals, such as set-top boxes and digital TV-sets, are required by the market to become open and flexible. This is achieved by replacing several dedicated hardware components, performing specific media processing applications, by a central processing unit (CPU) on which equivalent media processing applications execute. Resources, such as CPU time, memory, and bus bandwidth, are shared between these applications. Here, preferably the CPU resource is considered.

Media processing applications have two important properties. First, they have resource demands that may vary significantly over time. This is due to the varying size and complexity of the media data they process. Secondly, they have real-time demands, which result in deadlines that may not be missed, in order to avoid e.g. hiccups in the output. Therefore, an ideal processing behavior is obtained by assigning a media processing application at least the amount of resources that it needs in a worst-case load situation. However, CPUs are expensive compared to dedicated components. To be cost-effective, resources should be assigned closer to the average-case load situation. In general, this leads to a situation in which media processing applications are unable to satisfy their real-time demands.

This problem can be dealt with by designing media processing applications in such a way that they can run in lower than default quality levels, leading to correspondingly lower resource demands. Such a scalable media processing application can be set to reduce its quality level if it risks missing a deadline. In this way, real-time demands can be satisfied, which results in a robust system.

Consider one scalable media processing application, hereafter referred to as the application. The application constantly fetches units of work from an input buffer, processes them, and writes them into an output buffer. To this end, the application periodically receives a fixed budget for processing. Units of work may vary in size and complexity of processing, hence the time required to process one unit of work is not fixed. The finishing of a unit of work is called a milestone. For each milestone there is a deadline. These deadlines are assumed to be strictly periodic in time. Obviously, deadline misses are to be prevented.

At each milestone, the relative progress is calculated of the application with respect to the periodic deadlines. The relative progress at a milestone is defined as the time until the deadline of the milestone, expressed in deadline periods. Obviously, this relative progress should be non-negative. Furthermore, there is an upper bound on relative progress, due to limited buffer sizes.

If the relative progress at a milestone turns out to be negative, one or more deadline misses have occurred. To prevent this, the quality level at which the application runs at each milestone is adapted. The problem is to choose this quality level, such that the following three objectives are met. First, the quality level at which a unit of work is processed should be as high as possible. Secondly, the number of deadline misses should be as low as possible. Finally, the number of quality level changes should also be as low as possible, because quality level changes are perceived as non-quality.

Remark that a resulting quality level control strategy is to be applied on-line, and executes on the same CPU as the application. Therefore, it should be efficient in the amount of required CPU time.

A common way to handle a stochastic decision problem is by modeling it as a Markov decision problem. See J. van der Wal, Stochastic Dynamic Programming, PhD Thesis, Mathematisch Centrum Amsterdam 1980.

At each milestone, the relative progress of the application is calculated. Here, the relative progress at a milestone is defined as the time until the deadline of the milestone, expressed in deadline periods.

Relative progress at milestones can be calculated as follows. Assume, without loss of generality, that the application starts processing at time t=0. The time of milestone m is denoted by cₘ. Next, the deadline of milestone m is denoted by dₘ. The deadlines are strictly periodic, which means that they can be written as
dₘ=d₀+mP,
where P is the period between two successive deadlines and d₀ is an offset. The relative progress at milestone m, denoted by pₘ, is now given by

$${ρ}_{m} = \frac{{d}_{m} - {c}_{m}}{P} = m - \frac{{c}_{m} - {d}_{0}}{P} \qquad ( 1 )$$

To illustrate the calculation of relative progress, consider the example timeline shown in FIG. 1. In this example, P=1 and d₀=1. The relative progress at milestones 1 up to 5, calculated using (1), is given by ρ₁=(d₁−c₁)/P=(2−1)/1=1, ρ₂=1.5, ρ₃=1, ρ₄=0, and ρ₅=0.5. Note that milestone 4 is just in time.

If the relative progress at a milestone m drops below zero, then [−ρₘ] deadline misses have occurred since the previous milestone. How deadline misses are dealt with, is application specific. Here, a work preserving approach is assumed, meaning that the just created output is not thrown away, but is used anyhow. One way would be to use this output at the first next deadline, which means that an adapted relative progress ρ′ₘ=ρₘ+[−ρₘ]≦0 is obtained. A conservative approach is assumed by choosing ρ′ₘ=0, i.e., the lowest possible value, which in a sense corresponds to using the output immediately upon creation. In other words, the deadline dₘ and next ones are postponed an amount of −ρₘP. Consequently, the relative progress at milestones using (1) can be calculated, however with a new offset d′₀=d₀−ρₘP.

This process is illustrated by means of the example timeline shown in FIG. 2. In this example, P=1 and d₀=0.5. Using (1), the following can be derived:ρ₁=0.5, ρ₂=0.5, and ρ₃=−0.5. The relative progress at milestone 3 has dropped below zero, so [−ρ₃]=1 deadline miss has occurred since milestone 2, viz. at t=3.5. Next, deadline d₃ is postponed to d′₃=c₃=4, and further deadlines are also postponed by an amount of 0.5. Continuing, ρ₄=0.5, and ρ₅=0.5 are found.

The state of the application at a milestone is naturally given by its relative progress. This, however, gives an infinitely large set of states, whereas a Markov decision problem requires a finite set. The latter is accomplished as follows: let p>0 denote the given upper bound on relative progress. The relative progress space between 0 and p is split up into a finite set π={(π₀, . . . , π_{n-1}} of n≧1 progress intervals

$${π}_{k} = [ \frac{k p}{n} , \frac{( k + 1 ) p}{n} ) ,$$

for k=0, . . . ,n-1. The lower bound and the upper bound of a progress interval π is denoted by π and \overline{π}, respectively.

At each milestone, a decision must be taken about the quality level at which the next unit of work will be processed. Hence, the set of decisions in the Markov decision problem corresponds to the set of quality levels at which the application can run. This set is denoted by Q.

Quality level changes are also taken into account, thus at each milestone the previously used quality level should be known. This can be realized by extending the set of states with quality levels. Therefore, the set of states becomes π×Q. The progress interval and the previously used quality level of the application in state i is denoted by π(i) and q(i), respectively.

A second element of which Markov decision problems consist is transition probabilities. Let pᵢⱼ^{q} denote the transition probability for making a transition from a state i at the current milestone to a state j at the next milestone, if quality level q is chosen to process the next unit of work. After the transition, q(j)=q, which means that pᵢⱼ^{q}=0 if q≠q (j). In the other case, the transition probabilities can be derived as follows.

Assume, without loss of generality, that the application is in state i at milestone m. For each quality level q, we introduce a random variable X_{q}, which gives the time that the application requires to process one unit of work in quality level q. If it is assumed that the application receives a computation budget b per period P, then the relative progress ρₘ₊₁ can be expressed in ρₘ by means of the recursive equation

$${ρ}_{m + 1} = ( {ρ}_{m} + 1 - \frac{{X}_{q}}{b} ) {\vert}_{[ 0 , p ]} , \qquad ( 2 )$$

where the notation is used:

$$x {\vert}_{[ 0 , p ]} = \{ \begin{matrix}0 if x < 0 \\ x if 0 \leq x \leq p \\ p if x > p .\end{matrix}$$

Let Y_{π,ρm,q} be a random variable, which gives the probability that the relative progress ρₘ₊₁ of the application at the next milestone is in progress interval π, provided that the relative progress at the current milestone is πₘ and quality level q is chosen. Then it is derived:

$${Y}_{π , {p}_{m} , q} = \{ \begin{matrix}P ( {ρ}_{m + 1} < \overline{π} ) = 1 - P ( {ρ}_{m + 1} \geq \overline{π} ) if π = {π}_{0} \\ P ( {ρ}_{m + 1} \geq \underline{π} ) if π = {π}_{n - 1} \\ P ( \underline{π} \leq {ρ}_{m + 1} < \overline{π} ) = P ( {ρ}_{m + 1} \geq \underline{π} ) - P ( {ρ}_{m + 1} \geq \overline{π} ) otherwise .\end{matrix}$$

Let F_{q} denote the cumulative distribution function of X_{q}. Using recursive equation (2), it is derived for 0<×≦p

$$\begin{matrix}P ( {ρ}_{m + 1} \geq x ) = P ( {ρ}_{m} + 1 - \frac{{X}_{q}}{b} \geq x ) \\ = P ( {X}_{q} \leq b ( 1 - x + {ρ}_{m} ) ) \\ = {F}_{q} ( b ( 1 - x + {ρ}_{m} ) ) .\end{matrix}$$

For x=0, P(ρₘ₊₁≧x)=1, which follows directly from (2).

Unfortunately, the position of ρₘ within progress interval π(i) is unknown. A pessimistic approximation of ρₘ is obtained by choosing the lowest value in the interval. This gives an approximation
\tilde{p}ₘ=π(i) (3)

Given the above, the probabilities pᵢⱼ^{q} can be approximated by

$${\tilde{p}}_{i j}^{q} = \{ \begin{matrix}1 - {F}_{q} ( b ( 1 - \overline{π} ( j ) + \underline{π} ( i ) ) ) & if π ( j ) = {π}_{0} \\ {F}_{q} ( b ( 1 - \underline{π} ( j ) + \underline{π} ( i ) ) ) & if π ( j ) = {π}_{n - 1} \\ {F}_{q} ( b ( 1 - \underline{π} ( j ) + \underline{π} ( i ) ) ) - {F}_{q} ( b ( 1 - \overline{π} ( j ) + \underline{π} ( i ) ) ) & otherwise .\end{matrix}$$

The more progress intervals are chosen, the more accurate the modeling of the transition probabilities is, as the approximation in (3) is better.

A third element of which Markov decision problems consist is revenues. The revenue for choosing quality level q in state i is denoted by rᵢ^{q}. Revenues are used to implement the three problem objectives.

First, the quality level at which the units of work are processed should be as high as possible. This is realized by assigning a reward to each rᵢ^{q}, which is given by a function u(q). This function is referred to as the utility function. It returns a positive value, directly related to the perceptive quality of the output of the application running at quality level q.

Secondly, the number of deadline misses should be as low as possible. One or more deadline misses have occurred if the relative progress at a milestone drops below zero. Assuming that the application is in state i at milestone m, the expected number of deadline misses before reaching milestone m+1 is given by

$$\begin{matrix}{\sum }_{k = 1}^{∞} k P ( - k \leq {ρ}_{m} + 1 - \frac{{X}_{q}}{b} < - k + 1 ) = \\ {\sum }_{k = 1}^{∞} k P ( k + {ρ}_{m} < \frac{{X}_{q}}{b} \leq k + 1 + {ρ}_{m} ) = \\ {\sum }_{k = 1}^{∞} k [ {F}_{q} ( b ( k + 1 + {ρ}_{m} ) ) - {F}_{q} ( b ( k + {ρ}_{m} ) ) ] {\approx }^{( 3 )} \\ {\sum }_{k = 1}^{∞} k [ {F}_{q} ( b ( k + 1 + \underline{π} ( i ) ) ) - {F}_{q} ( b ( k + \underline{π} ( i ) ) ) ] .\end{matrix}$$

After multiplying this expected number of deadline misses with a positive constant, named the deadline miss penalty, we subtract it from each rᵢ^{q} to implement a penalty on deadline misses.

Finally, the number of quality level changes should be as low as possible. This is accomplished by subtracting a penalty, given by a function c(q(i),q), from each rᵢ^{q}. This function returns a positive value, which may increase with the size of the gap between q(i) and q, if q(i)≠q, and 0 otherwise. Furthermore, an increase in quality may be given a lower penalty than a decrease in quality. The function c(q(i),q) is referred to as the quality change function.

If only a finite number of transitions are considered (a so-called finite time horizon), the solution of a Markov decision problem is given by a decision strategy that maximizes the sum of the revenues over all transitions, which can be found by means of dynamic programming. However, we have an infinite time horizon, because we cannot limit the number of transitions. In that case, a useful criterion to maximize is given by the average revenue per transition. This criterion emphasizes that all transitions are equally important. There are a number of solution techniques for the infinite time horizon Markov decision problem, such as successive approximation, policy iteration, and linear programming. See for example Martin L. Puterman, Markov Decision Processes: Discrete Stochastic Dynamic Programming, Wiley Series in Probability and Mathematical Statistics, John Wiley & Sons Inc. 1994 and D. J. White, Markov Decision Processes, John Wiley & Sons Inc. 1993. For the experiments described here, successive approximation is used.

Solving the Markov decision problem results in an optimal stationary strategy. Stationary here means that the applied decision strategy is identical at all milestones, i.e. it does not depend on the number of the milestone. An example control strategy, for |π|=1014, |Q|=4, and p=2 is shown in FIG. 4. It says that, for example, if the relative progress at a particular milestone is 1, and if the previously used quality level is q₁, then quality level q₂ should be chosen to process the next unit of work.

Without loss of optimality, so-called monotonic control strategies can be used, i.e., per previously used quality level it can be assumed that a higher relative progress results in a higher or equal quality level choice. Then, for storing an optimal control strategy, per previously used quality level only the relative progress bounds at which the control strategy changes from a particular quality level to another one have to be stored. A control strategy therefore has a space complexity of O(|Q|²), which is independent of the number of progress intervals.

The Markov decision problem can be solved off-line, before the application starts executing. Next, we apply the resulting control strategy on-line, as follows. At each milestone, the previously used quality level is known, and the relative progress of the application is calculated. Then, the quality level at which the next unit of work is to be processed is looked up. This approach requires little overhead.

As input for the experiments an MPEG-2 decoding trace file of a movie fragment of 539 frames is used. This file contains for each frame the processing time required to decode it, expressed in CPU cycles on a TriMedia, in each of four different quality levels, labeled q₀ up to q₃ in increasing quality order. From the trace file, for each quality level, a cumulative distribution function of the processing time required to decode one frame is derived, as shown in FIG. 3. FIG. 3 illustrates the cumulative distribution function of the processing time required to decode one frame, for quality levels q₀ up to q₃.

The problem parameters are defined as follows. The upper bound on relative progress p is chosen equal to 2, which assumes that an output buffer is used that can store two decoded frames. The utility function is defined by u(q₀)=1, u(q₁)=5, u(q₂)=7.5 and u(q₃)=10. The deadline miss penalty is chosen equal to 1000, which means that roughly about 1 deadline miss per 100 frames is allowed. The quality change function is defined by a penalty of 5 times the difference in number of quality levels for increasing the quality level, and 6 for decreasing the quality level. Next, 57 different values for the budget b is used, varying from 2,200,000 to 3,600,000 CPU cycles, using incremental steps of 25,000 CPU cycles. For each budget b 20 different numbers of progress intervals are chosen, varying from |π|=30 to |π|=1014, taking multiplicative steps of 1.2. In this way, in total 1140 Markov decision problem instances are defined.

As mentioned, the successive approximation algorithm is used to solve the problem instances. Apart from a calculation inaccuracy, this algorithm finds optimal control strategies. We use a value of 0.001 for the inaccuracy parameter. The resulting control strategies give at each milestone the quality level at which the next frame should be decoded, given the relative progress and the previously used quality level. For each computed control strategy, the execution of a scalable MPEG-2 decoder is simulated using this control strategy. These simulations make use of processing times from a synthetically created trace file, based on the given processing time distributions, but consisting of 30,000 frames instead of 539. In each simulation, q₀ as initial quality level is chosen, and the actual average revenue per transition, the quality level usage, the percentage of deadline misses, and the changes in quality level are measured.

The number of progress intervals |π| are varied from 30 to 1014, taking multiplicative steps of 1.2, which results in 20 problem instances per budget. FIG. 4 shows the resulting optimal control strategy for b=3,100,000 and |π|=1014. As we can see, the control strategy indeed exhibits a tendency to maintain the used quality level.

FIG. 5 shows the average revenue per transition for the 20 problem instances with b=3,100,000, as found in the computations required to solve the problem instances, and the actual value measured in the simulations. The average revenue in the simulations quickly converges to a value of about 8.27. The average revenue in the computations needs more progress intervals to converge to this value, which is due to the pessimistic approximation in (3) Nevertheless, the control strategies from about |π|=200 already result in an average revenue of about 8.27 in the simulations. In other words, not that many progress intervals are needed to find a (near) optimal control strategy.

Next, FIGS. 6-8 show the three constituents of the revenues, where FIG. 6 shows the quality level usage, FIG. 7 the percentage of deadline misses, and FIG. 8 the average increment in quality level, as measured in the simulations of all problem instances with |π|=1014. The average decrement in quality level is not depicted, since it is almost identical to the average increment in quality level. If the budget increases, then more often a higher quality level is chosen, and the percentage of deadline misses drops steeply to zero at b=2,650,000. The low percentage of deadline misses for larger budgets is due to the relative high deadline miss penalty. It is further observed that the average increment and the average decrement in quality level are low. Therefore, is can be concluded that all three problem objectives are met.

To give an example how the three constituents contribute to the average revenue, consider the case |π|=1014 and b=3,100,000. For this, there is an average quality level utility of 0.0033*1+0.0102*5+0.5953*7.5+0.3911*10=8.43, an average deadline miss penalty of 0*1000=0, and an average quality level increase penalty of 0.0145*5=0.07 and decrease penalty of 0.0144*6=0.09. This results in the total average revenue of 8.27 per frame.

Solving a Markov decision problem by means of successive approximation involves a kind of state vector, which contains a value for each state in π×Q. Usually, the state vector is initialized to the zero vector. Then, iteratively, optimal decisions are determined for all states, and the state vector is updated. The iterative procedure ends when the difference between two successive state vectors contains all (nearly) identical entries (the average revenue per transition), i.e., when the minimum and maximum difference are within the specified inaccuracy range.

As for each budget b we solve the same Markov decision problem repeatedly, with different numbers of progress intervals, a different way to initialize the state vector is used. For each budget b, the first time we solve the Markov decision problem, i.e., with the lowest number of progress intervals (30), the zero vector for initialization is used. For each next number of progress intervals, the state vector is initialized by interpolating the final state vector of the run with the previous number of progress intervals. In this way, the successive approximation algorithm is expected to need fewer iterations to converge.

To test how good this interpolation vector approach works, it is compared to the straightforward approach of always choosing the zero vector as initial vector. To this end we solved the Markov decision problem for b=3, 100,000 using both vector approaches, where the number of progress intervals is varied from |π|=30 to |π|=1749, taking multiplicative steps of 1.5. FIG. 9 shows the number of iterations required for both approaches. FIG. 10 shows the computation time that is measured for both approaches, using a Pentium II Xeon 400 MHz processor. In the latter figure the cumulative computation time for the interpolation vector approach is also shown. The figure shows that if this Markov; decision problem is solved for a large number of progress intervals, it may be better to use the interpolation vector approach and solve the Markov decision problem several times, for increasing numbers of progress intervals, as this may result in a lower total computation time than if we solve the Markov decision problem directly for the requested number of progress intervals.

Quality level control for scalable media processing applications having fixed CPU budgets were modeled as a Markov decision problem. The model is based on relative progress of the application, calculated at milestones. Three problem objectives were defined, being maximizing the quality level at which units of work are processed, minimizing the number of deadline misses, and minimizing the number of quality level changes. A parameter in the model is the number of progress intervals.

The more progress intervals are chosen, the more accurate the modeling of the problem becomes. Solving the Markov decision problem results in an optimal control strategy, which can be applied during run time with only little overhead.

To evaluate the approach, in total 1140 problem instances were solved concerning a scalable MPEG-2 decoder. For each of the resulting control strategies, the execution of the decoder was simulated. From this experiment it was concluded that although some progress intervals were needed to have a good approximation by the model, an optimal control strategy can be obtained with relatively few progress intervals. Furthermore, for this experiment it can be concluded that the approach meets the three problem objectives.

In solving a Markov decision problem using successive approximation, the state vector was initialized using an interpolation vector approach. It was observed that for large numbers of progress intervals, it may be better to use the interpolation vector approach and solve the problem several times, for increasing numbers of progress intervals, as this may result in a lower total computation time than if the problem was solved directly for the requested number of progress intervals.

A resulting quality level control strategy can be applied on-line, and execute on the same processor as the application.

Another work preserving approach is to use the output at the first next deadline, which results in an adapted relative progress ρₘ:=ρₘ+┌−ρₘ┐≧0. This is for instance applicable for MPEG-2 decoding, where upon a deadline miss the previously decoded frame can be displayed, and the newly decoded frame is displayed one frame period later. Calculating the relative progress at milestones using (1), can be used however with a new offset d₀:=d₀+┌−ρₘ┐P We refer to this approach as the skipping deadline miss approach.

The skipping deadline miss approach is illustrated by means of the example timeline shown in FIG. 11. In the example, P=1 and d₀=0. Using (1), ρ₁=0.5, ρ₂=0, and ρ₃=−0.5 are derived. The relative progress at milestone 3 has dropped below zero, so ┌−ρ₃┐=1 deadline miss had occurred since milestone 2, viz. at time t=3. Next, ρ₃ is adapted to 0.5, and a new offset is used d₀:=0+┌−0.5┐1=1, then ρ₄=1, and ρ₅=0, are found.

Note that this model can be generalized in such a way that negative relative progress is allowed within specified bounds. However, here it is assumed a lower bound of zero.

Assume, without loss of generality, that the application is in state i at milestone m. For each quality level q, a random variable X_{tq} is introduced, which gives the time that the application requires to process one unit of work of type t in quality level q. If it is assumed that the application receives a computation budget b per period P, then ρₘ₊₁ in ρₘ can be expressed as follows. First, without considering the bounds 0 and p on relative progress, a new relative progress is found

$${ρ}_{m + 1}^{unb} = {ρ}_{m} + 1 - \frac{{X}_{t q}}{b} . \qquad ( 4 )$$

However, if this drops below zero, deadline misses are encountered, so an adapted relative progress is found. Furthermore, if ρₘ₊₁^{unb}, exceeds p, then the processor will have been stalled because the output buffer is full, in which case there is an adapted relative progress of p. If the conservative deadline miss approach is applied, the new relative progress is given by

$${ρ}_{m + 1} = {c}_{p} ( {ρ}_{m + 1} ) = {c}_{p} ( {ρ}_{m} + 1 - \frac{{X}_{t q}}{b} ) \qquad ( 5 )$$

where the notation is used:

$${c}_{p} ( x ) = \{ \begin{matrix}0 & if x < 0 \\ x & if 0 \leq x \leq p \\ p & if x > p .\end{matrix}$$

If the skipping deadline miss approach is used, the new relative progress is given by

$${ρ}_{m + 1} = {s}_{p} ( {ρ}_{m + 1} ) = {s}_{p} ( {ρ}_{m} + 1 - \frac{{X}_{tq}}{b} ) \qquad ( 6 )$$

where the notation is used:

$${s}_{p} ( x ) = \{ \begin{matrix}x + ⌈ - x ⌉ & if x < 0 \\ x & if 0 \leq x \leq p \\ p & if x > p .\end{matrix}$$

Let Y_{ρ}_{_{m,}}ₜ_{_{m,}}_{π,t}_{_{m+1,}}_{q} be a random variable, which gives the probability that the relative progress ρₘ+1 of the application at milestone m+1 is in progress interval π, and that the type of the next unit of work at milestone m+1 is tₘ+1, provided that the relative progress at milestone m is ρₘ, the type of the next unit of work at milestone m is tₘ, and quality level q is chosen to process this unit of work. Moreover, let Pr (tₘ, tₘ₊₁) denote the probability that a unit of work of type tₘ₊₁ follows upon a unit of work of type tₘ. Then it is derived

$${Y}_{{ρ}_{m} , {t}_{m} , π , {t}_{m + 1} , q} = Pr ( {t}_{m} , {t}_{m + 1} ) \cdot \{ \begin{matrix}1 - Pr ( {ρ}_{m + 1} \geq \overline{π} ) & if π = {π}_{0} \\ Pr ( {ρ}_{m + 1} \geq \underline{π} ) & if π = {π}_{n - 1} \\ \begin{matrix}Pr ( {ρ}_{m + 1} \geq \underline{π} ) - \\ Pr ( {ρ}_{m + 1} \geq \overline{π} )\end{matrix} & otherwise .\end{matrix}$$

Let F_{tq} denote the cumulative distribution function of X_{tq}, i.e., F_{tq}(x)=Pr(X_{tq}≦x). For the conservative deadline miss approach, using recursive equation (3), it is derived for 0<x≦p

$$\begin{matrix}Pr ( {ρ}_{m + 1} \geq x ) = Pr ( {ρ}_{m} + 1 - \frac{{X}_{tq}}{b} \geq x ) \\ = {F}_{tq} ( b ( {ρ}_{m} + 1 - x ) ) .\end{matrix}$$

For the skipping deadline miss approach, using recursive equation (6), it is derived for 0<x<1

$$\begin{matrix}Pr ( {ρ}_{m + 1} \geq x ) = Pr ( {ρ}_{m} + 1 - \frac{{X}_{tq}}{b} \geq x ) + \\ {\sum }_{k = 1}^{∞} Pr ( x - k \leq {ρ}_{m} + 1 - \frac{{X}_{tq}}{b} < - k + 1 ) \\ = {F}_{tq} ( b ( {ρ}_{m} + 1 - x ) ) + {\sum }_{k = 1}^{∞} ( {F}_{tq} ( b ( {ρ}_{m} + 1 - x + k ) ) ) - \\ {\sum }_{k = 1}^{∞} ( {F}_{tq} ( b ( {ρ}_{m} + k ) ) ) , \\ and for 1 \leq x \leq p \\ Pr ( {ρ}_{m + 1} \geq x ) = Pr ( {ρ}_{m} + 1 - \frac{{X}_{tq}}{b} \geq x ) \\ = {F}_{tq} ( b ( {ρ}_{m} + 1 - x ) ) .\end{matrix}$$

Unfortunately, the exact position of ρₘ within progress interval π(i) is unknown. A pessimistic approximation of ρₘ is obtained by choosing the lowest value in the interval. This gives an approximation
\tilde{P}ₘ=π(i). (7)

Given the above, the transition probabilities pᵢⱼ^{q}, can in case of the conservative deadline miss approach be approximated by

$${\tilde{ρ}}_{ij}^{q} = Pr ( t ( i ) , t ( j ) ) \cdot \{ \begin{matrix}1 - {F}_{t ( i ) q} ( b ( \underline{π} ( i ) + 1 - \overline{π} ( j ) ) ) & if π ( j ) = {π}_{0} \\ {F}_{t ( i ) q} ( b ( \underline{π} ( i ) + 1 - \underline{π} ( j ) ) ) & if π ( j ) = {π}_{n - 1} \\ \begin{matrix}{F}_{t ( i ) q} ( b ( \underline{π} ( i ) + 1 - \underline{π} ( j ) ) ) - \\ {F}_{t ( i ) q} ( b ( \underline{π} ( i ) + 1 - \overline{π} ( j ) ) )\end{matrix} & otherwise ,\end{matrix}$$

and in case of the skipping deadline miss approach by

$$\begin{matrix}{\tilde{p}}_{ij}^{q} = Pr ( t ( i ) , t ( j ) ) \cdot \\ \{ \begin{matrix}1 - {F}_{t ( i ) q} ( b ( \underline{π} ( i ) + 1 - \overline{π} ( j ) ) ) - & \\ {\sum }_{k = 1}^{∞} ( {F}_{t ( i ) q} ( b ( \underline{π} ( i ) + 1 - \overline{π} ( j ) + k ) ) ) + & \\ {\sum }_{k = 1}^{∞} ( {F}_{t ( i ) q} ( b ( \underline{π} ( i ) + k ) ) ) & if π ( j ) = {π}_{0} ⋀ \overline{π} ( j ) < 1 \\ & \\ 1 - {F}_{t ( i ) q} ( b ( \underline{π} ( i ) + 1 - \overline{π} ( j ) ) ) & if π ( j ) = {π}_{0} ⋀ \overline{π} ( j ) \geq 1 \\ & \\ {F}_{t ( i ) q} ( b ( \underline{π} ( i ) + 1 - \underline{π} ( j ) ) ) + & \\ {\sum }_{k = 1}^{∞} ( {F}_{t ( i ) q} ( b ( \underline{π} ( i ) + 1 - \underline{π} ( j ) + k ) ) ) - & \\ {\sum }_{k = 1}^{∞} ( {F}_{t ( i ) q} ( b ( \underline{π} ( i ) + k ) ) ) & if π ( j ) = {π}_{n - 1} ⋀ \underline{π} ( j ) < 1 \\ & \\ {F}_{t ( i ) q} ( b ( \underline{π} ( i ) + 1 - \underline{π} ( j ) ) ) & if π ( j ) = {π}_{n - 1} ⋀ \underline{π} ( j ) \geq 1 \\ & \\ {F}_{t ( i ) q} ( b ( \underline{π} ( i ) + 1 - \underline{π} ( j ) ) ) - & \\ {F}_{t ( i ) q} ( b ( \underline{π} ( i ) + 1 - \overline{π} ( j ) ) ) + & \\ {\sum }_{k = 1}^{∞} ( {F}_{t ( i ) q} ( b ( \underline{π} ( i ) + 1 - \underline{π} ( j ) + k ) ) ) - & \\ {\sum }_{k = 1}^{∞} ( {F}_{t ( i ) q} ( b ( \underline{π} ( i ) + 1 - \overline{π} ( j ) + k ) ) ) & if π ( j ) ∉ \{ {π}_{0} , {π}_{n - 1} \} ⋀ \overline{π} ( j ) < 1 \\ & \\ {F}_{t ( i ) q} ( b ( \underline{π} ( i ) + 1 - \underline{π} ( j ) ) ) - & \\ {F}_{t ( i ) q} ( b ( \underline{π} ( i ) + 1 - \overline{π} ( j ) ) ) & if π ( j ) ∉ \{ {π}_{0} , {π}_{n - 1} \} ⋀ \underline{π} ( j ) \geq 1 \\ & \\ {F}_{t ( i ) q} ( b ( \underline{π} ( i ) + 1 - \underline{π} ( j ) ) ) - & \\ {F}_{t ( i ) q} ( b ( \underline{π} ( i ) + 1 - \overline{π} ( j ) ) ) + & \\ {\sum }_{k = 1}^{∞} ( {F}_{t ( i ) q} ( b ( \underline{π} ( i ) + 1 - \underline{π} ( j ) + k ) ) ) - & \\ {\sum }_{k = 1}^{∞} ( {F}_{t ( i ) q} ( b ( \underline{π} ( i ) + k ) ) ) & otherwise .\end{matrix}\end{matrix}$$

Clearly, the more progress intervals are chosen, the more accurate the modeling of the transition probabilities will be, as the approximation in (7) will be better. Note that the conservative deadline miss approach is a worst-case scenario for the skipping deadline miss approach. So, when applying the skipping deadline miss approach, the transition probabilities of the conservative deadline miss approach may be used to solve the Markov decision problem.

Solving the Markov decision problem requires many repeated instances of

$${\tilde{p}}_{ij}^{q} .$$

First computing and storing all values

$${\tilde{p}}_{ij}^{q}$$

requires a space complexity of O(|π|²·|Q|·|T|) for the probabilities of the progress interval transitions, and a space complexity of O(|T|²) for the probabilities of the type transitions. Assuming that |T| is small, this is only feasible if there is a small number of progress intervals. Otherwise, computing the values

$${\tilde{p}}_{ij}^{q}$$

on the fly is the solution. This, however, results in many redundant computations, each of which involves accessing a cumulative distribution function. Computing the value of a cumulative distribution function F has a logaritmic time complexity in the granularity of F.

If the conservative deadline miss approach is applied, it is often advantageous to calculate transition probabilities in the following alternative way. Assume, without loss of generality, that the application is in state i at milestone m. Recall that n=|π| and that the width of one progress interval is given by

$$\frac{p}{n} .$$

Using the pessimistic approximation (7), let Pr(Δ_{t(i)q}=k) for 1−n≦k≦n−1 denote the probability of having moved k progress intervals after processing the next unit of work of type t (i) in quality level q. This probability is given by

$$Pr ( {Δ}_{t ( i ) q} = k ) = \{ \begin{matrix}Pr ( 1 - \frac{{X}_{t ( i ) q}}{b} < \frac{( k + 1 ) p}{n} ) = & \\ 1 - Pr ( 1 - \frac{{X}_{t ( i ) q}}{b} \geq \frac{( k + 1 ) p}{n} ) = & \\ 1 - {F}_{t ( i ) q} ( b ( 1 - \frac{( k + 1 ) p}{n} ) ) & if k = 1 - n \\ & \\ Pr ( \frac{kp}{n} \leq 1 - \frac{{X}_{t ( i ) q}}{b} < \frac{( k + 1 ) p}{n} ) = & \\ Pr ( 1 - \frac{{X}_{t ( i ) q}}{b} \geq \frac{kp}{n} ) - & \\ Pr ( 1 - \frac{{X}_{t ( i ) q}}{b} \geq \frac{( k + 1 ) p}{n} ) = & \\ {F}_{t ( i ) q} ( b ( 1 - \frac{kp}{n} ) ) - & \\ {F}_{t ( i ) q} ( b ( 1 - \frac{( k + 1 ) p}{n} ) ) & if 1 - n < k < n - 1 \\ & \\ Pr ( 1 - \frac{{X}_{t ( i ) q}}{b} \geq \frac{kp}{n} ) = & \\ {F}_{t ( i ) q} ( b ( 1 - \frac{kp}{n} ) ) & if k = n - 1.\end{matrix}$$

Now let integers a and b be defined by πₐ=π(i) and π_{b}=π(j). Then the transition probabilities \tilde{p}ᵢⱼ^{q} are also given by

$${\tilde{p}}_{ij}^{q} = Pr ( t ( i ) , t ( j ) ) \cdot \{ \begin{matrix}{\sum }_{k = - n + 1}^{b - a} Pr ( {Δ}_{t ( i ) q} = k ) & if b = 0 \\ Pr ( {Δ}_{t ( i ) q} = b - a ) & if 0 < b < n - 1 \\ {\sum }_{k = b - a}^{n - 1} Pr ( {Δ}_{t ( i ) q} = k ) & if b = n - 1.\end{matrix} \qquad ( 8 )$$

The values \tilde{p}ᵢⱼ^{q} can be calculated in advance and stored in a space complexity of O(|π|·|Q|·|T|) for the probabilities of the progress interval transitions, which is linear in |π|, and in a space complexity of O(|T|²) for the probabilities of the type transitions. This alternative way to compute transition probabilities speeds up solving the Malkov decision problem significantly.

FIG. 12 illustrates a system 1200 according to the invention in a schematic way. The system 1200 comprises memory 1202 that communicates with the central processing unit 1210 via software bus 1208. Memory 1202 comprises computer readable code 1204 designed to determine the amount of CPU cycles to be used for processing a media frame as previously described. Further, memory 1202 comprises computer readable code 1206 designed to control the quality of the media frame based on relative progress of the media processing application calculated at a milestone. Preferably, the quality of processing the media frame is set based upon a Markov decision problem that is modeled for processing a number of media frames as previously described. The computer readable code can be updated from a storage device 1212 that comprises a computer program product designed to perform the method according to the invention. The storage device is read by a suitable reading device, for example a CD reader 1214 that is connected to the system 1200. The system can be realized in both hardware and software or any other standard architecture able to operate software.

FIG. 13 illustrates a television set 1310 according to the invention in a schematic way that comprises an embodiment of the system according to the invention. Here, an antenna, 1300 receives a television signal. Any device able to receive or reproduce a television signal like, for example, a satellite dish, cable, storage device, internet, or Ethernet can also replace the antenna 1300. A receiver, 1302 receives the television signal. Besides the receiver 1302, the television set contains a programmable component, 1304, for example a programmable integrated circuit. This programmable component contains a system according to the invention 1306. A television screen 1308 shows the document that is received by the receiver 902 and is processed by the programmable component 1304. The television set 1310 can, optionally, comprise or be connected to a DVD player 1312 that provides the television signal.

FIG. 14 illustrates, in a schematic way, the most important parts of a set-top box 1402 that comprises an embodiment of the system according to the invention. Here, an antenna 1400 receives a television signal. The antenna may also be for example a satellite dish, cable, storage device, internet, Ethernet or any other device able to receive a television signal. A set-top box 1402, receives the signal. The signal may be for example digital. Besides the usual parts that are contained in a set-top box, but are not shown here, the set-top box contains a system according to the invention 1404. The television signal is shown on a television set 1406 that is connected to the set-top box 1402.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. The word “comprising” does not exclude the presence of elements or steps other than those listed in a claim. The word “a” or “an” preceding a element does not exclude the presence of a plurality of such elements. The invention can be implemented by means of hardware comprising several distinct elements, and by means of a suitably programmed computer. In the system claims enumerating several means, several of these means can be embodied by one and the same item of computer readable software or hardware. The mere fact that certain measures are recited in mutually different dependent claims does not indicate that a combination of these measures cannot be used to advantage.

1. Method of setting a quality of a media frame by a media processing application, the method comprising:
a step of determining an amount of resources to be used for processing the media frame;
a step of controlling the quality of the media frame based on relative progress of the media processing application calculated at a milestone.

2. Method of setting a quality of a media frame according to claim 1, wherein controlling the quality of the media frame is modeled as a Markov decision problem comprising a set of states, a set of decisions, a set of transition probabilities and a set of revenues, and the method comprising:
defining the set of states to comprise the relative progress of the media processing application at a mile stone and a previously used quality of a previous media frame;
defining the set of decisions to comprise a plurality of qualities that the media processing application can provide;
defining the set of transition probabilities to comprise a probability that a transition is made from a state of the set of states at a current milestone to an other state of the set of states at a next milestone if a quality of the plurality of qualities is chosen; and
defining the set of revenues to comprise a positive revenue related to a positive quality of the media frame, a negative revenue related to a deadline miss and a negative revenue related to a quality change;
solving this Markov decision problem using a decision strategy and setting the quality of the media frame based upon this solution.

3. Method of setting a quality of a media frame according to claim 2, wherein the decision strategy comprises a step of maximizing a sum of revenues over all transitions.

4. Method of setting a quality of a media frame according to claim 2, wherein the decision strategy comprises a step of maximizing an average revenue per transition.

5. System to set a quality of a media frame by a media processing application, the system comprising:
determining means conceived to determine an amount of resources to be used for processing the media frame;
controlling means conceived to control the quality of the media frame based on relative progress of the media processing application calculated at a milestone.

6. System of setting a quality of a media frame according to claim 5, wherein the controlling means is conceived to model the control of the quality of the media frame as a Markov decision problem comprising a set of states, a set of decisions, a set of transition probabilities and a set of revenues, wherein:
the set of states comprises the relative progress of the media processing application at a mile stone and a previously used quality of a previous media frame;
the set of decisions comprises a plurality of qualities that the media processing application can provide;
the set of transition probabilities comprises a probability that a transition is made from a state of the set of states at a current milestone to an other state of the set of states at a next milestone if a quality of the plurality of qualities is chosen; and
the set of revenues comprises a positive revenue related to a positive quality of the media frame, a negative revenue related to a deadline miss and a negative revenue related to a quality change; and
the controlling means is further conceived to solve this Markov decision problem using a decision strategy and set the quality of the media frame based upon this solution.

6. A computer program product designed to perform the method according to claim 1.

7. A storage device comprising a computer program product according to claim 6.

8. A television set comprising a system according claim 5.

9. A set-top box comprising a system according claim 5.
